(19) United States
(12) Patent Application Publication
(10) Pub. No.: US 2020/0065287 A1
(43) Pub. Date: Feb. 27, 2020

(54) NETWORKING SYSTEMS USING MULTIPLE PERIPHERAL COMPONENT CARDS

(71) Applicant: General Electric Company, Schenectady, NY (US)

(72) Inventors: Oliver Grafe, Augsburg (DE); Edgar Merger, Leutkirch (DE)

(21) Appl. No.: 16/107,014

(22) Filed: Aug. 21, 2018

(51) Int. Cl. G06F 13/40; G06F 1/18; G06F 13/42

(52) U.S. Cl. CPC G06F 13/4059; G06F 13/423; G06F 1/186; G06F 1/185

(57) ABSTRACT

A multi-card system is provided. The multi-card system includes a first peripheral component card comprising a first communication extension port and a second communication extension port. The multi-card system also includes a second peripheral component card comprising a first communication extension port and a second communication extension port. The multi-card system also includes a first adapter board coupled to the first peripheral component card at the first communication extension port of the first peripheral component card. The first adapter board is also coupled to the second peripheral component card at the first communication extension port of the second peripheral component card. The first peripheral component card is coupled to a motherboard and is configured to transmit data to the second peripheral component card via the first adapter board.

### BACKGROUND

The disclosure generally relates to networking systems using peripheral component cards, and more specifically for connecting multiple network cards in a system to act as a single network card.

Peripheral component cards are used in a wide variety of computer applications, such as, for networking operations, data storage applications, peripheral component connections, and video processing, among others. For networking applications, peripheral component cards may be used to connect a computer with a network by, an Ethernet connection, for example. A peripheral component card may interface with the computer via a peripheral component interconnect (PCI). For synchronous digital circuit systems, a PCI-Express (PCIe) communication bus may also be used to eliminate skew and to increase bandwidth.

### SUMMARY

In one aspect, a multi-card system is provided. The multi-card system includes a first peripheral component card comprising a first communication extension port and a second communication extension port. The multi-card system also includes a second peripheral component card comprising a first communication extension port and a second communication extension port. The multi-card system also includes a first adapter board coupled to the first peripheral component card at the first communication extension port of the first peripheral component card. The first adapter board is also coupled to the second peripheral component card at the first communication extension port of the second peripheral component card. The first peripheral component card is coupled to a motherboard and is configured to transmit data to the second peripheral component card via the first adapter board.

In another aspect, a peripheral component card is provided. The peripheral component card includes a first communication extension port for transmitting and receiving a clock signal and for transmitting and receiving data. The peripheral component card also includes a second communication extension port for transmitting and receiving a clock signal and for transmitting and receiving data. The peripheral component card also includes a plurality of peripheral component ports. The peripheral component card also includes a processor communicatively coupled to the first communication extension port, the second communication extension port, and the plurality of component ports. The processor is programmed to receive a clock signal, transmit data synchronized to the clock signal to one of the first communication extension port and second communication extension port, and transmit data synchronized to the clock signal to at least one of the plurality of peripheral component ports.

In another aspect, a method for operating a multi-card system is provided. The multi-card system includes a first peripheral component card with a first communication extension port, a second communication extension port, and a processor. The multi-card system also includes a second peripheral component card comprising a first communication extension port and a second communication extension port. The multi-card system also includes a first adapter board coupled to the first peripheral component card at the first communication extension port of the first peripheral component card. The first adapter board is also coupled to the second peripheral component card at the first communication extension port of the second peripheral component card. The first peripheral component card is coupled to the motherboard. The method includes transmitting and receiving, by the processor on the first peripheral component card, data to the second peripheral component card via the first adapter board.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is a block diagram of an example peripheral component card for a multi-card system, in accordance with one embodiment of the disclosure.

FIG. 2 is a block diagram of an example adapter board for a multi-card system, in accordance with one embodiment of the disclosure.

FIG. 3 is a flow diagram of an example peripheral component card using the example adapter board shown in FIG. 2 for a multi-card system, in accordance with one embodiment of the disclosure.

FIG. 4 illustrates an example four-card system using the peripheral component card shown in FIG. 1 and adapter board shown in FIG. 2, in accordance with one embodiment of the disclosure.

FIGS. 5A and 5B illustrate examples of two-card systems using the peripheral component card shown in FIG. 1 and the adapter board shown in FIG. 2, in accordance with one embodiment of the disclosure.

FIG. 6 is a flow diagram of the clock signal distribution of the peripheral component card shown in FIG. 1 with an example clock generator, in accordance with one embodiment of the disclosure.

FIG. 7 is a flow diagram of the clock signal distribution of the peripheral component card shown in FIG. 1 with example external clock signal, in accordance with one embodiment of the disclosure.

FIG. 8 is a flow diagram of an example clock synchronization with the peripheral component card as shown in FIG. 6 and the peripheral component card shown in FIG. 7, in accordance with one embodiment of the disclosure.

FIG. 9 is a flow diagram of an example three-card system using the peripheral component card shown in FIG. 1, in accordance with one embodiment of the disclosure.

FIG. 10 illustrates an example redundancy network using the peripheral component card as shown in FIG. 1, in accordance with one embodiment of the disclosure.

FIG. 11 illustrates an example redundancy network using a multi-card system, in accordance with one embodiment of the disclosure.

FIG. 12 is a simplified block diagram of an example user computing device that may be used with the peripheral component card shown in FIG. 1, in accordance with one embodiment of the disclosure.

### DETAILED DESCRIPTION

Exemplary methods and systems are disclosed that facilitate a multi-card system that utilizes multiple peripheral component cards for providing redundancy and easily expandable peripheral component port connections. The multi-card system includes passive interconnection bridges, or adapter boards, that facilitate communication between the peripheral component cards. Each peripheral component card includes at least two adapter board communication interfaces, or communication extension ports. The methods described herein for a multi-card system are not limited to two cards. Multiple peripheral component cards may be used to achieve a desired result. Any number of peripheral component cards as are able to be supported by the infrastructure may be interconnected to each other.

In a multi-card system, multiple peripheral component cards are used and each includes at least a processor and may include other components (e.g., for communication via a bus) based on the particular application. Each peripheral component card in the system is in communication with at least one other peripheral component card using at least one adapter board coupled to a respective communication extension port. The adapter boards may be staggered in an alternating pattern to achieve a multi-card configuration described below.

In the exemplary embodiment, the peripheral component cards are configured for networking. Each peripheral component card in the multi-card system includes at least one peripheral component port configured for network communication. Each peripheral component card is also coupled to a motherboard. A first peripheral component card is in communication with a processor on the motherboard and/or a memory device on the motherboard. A second peripheral component card can, but does not need to communicate with the motherboard. Data received via the peripheral component ports on the second peripheral component card is transmitted to the motherboard via an adapter board connecting the first and second peripheral component cards. In this configuration, use of the multi-card system is simplified by the illusion that a single card is connected to the motherboard. In some embodiments, the multi-card system operates independently (e.g., in a standalone format) from the motherboard and may be configured with on-board and/or separate memory storage areas for data storage.

The multi-card configuration using adapter boards also optimizes utilization of the available bandwidth to the host CPU over, for example, a single lane peripheral component interconnect express (PCIe) interface while simultaneously providing redundancy (e.g., for when a single card or component in the multi-card system fails). For example, the peripheral component ports may be RJ-45 ports for communication over, for example, Ethernet. In a two-card system, each peripheral component card may include four RJ-45 ports for a total of eight RJ-45 ports. Additional peripheral component cards may be added to increase the number of available RJ-45 ports.

The use of passive adapter bridges provides a cost-effective way to implement a multi-card system requiring multiple peripheral component ports. For example, a PCIe x1 card edge connector conforming to the peripheral component interconnect special interest group dimensional requirements (PCI-SIG) may be used as a low-cost implementation of the multi-card system. The multi-card system implemented using identical peripheral component cards provides additional cost benefits.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Approximating language, as used herein throughout the specification and claims, may be applied to modify any quantitative representation that may permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and interchanged; such ranges are identified and include all the sub-ranges contained therein unless context or language indicates otherwise.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program stored in memory for execution by personal computers, workstations, clients, servers, industrial controllers and vehicle controllers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously. The embodiments described herein may be configured for time-sensitive networking (TSN) or other real-time applications.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The methods and system described herein may be implemented using computer programming or engineering techniques including computer software, firmware, hardware, or any combination or subset. As disclosed above, at least one technical problem with prior systems is that there is a need for systems capable of multiple peripheral port connections having synchronized clock signals. The system and methods described herein address that technical problem. The technical effect of the systems and processes described herein is achieved by adapter boards capable of high speed data communication and clock signal synchronization. The resulting technical effect is the connection of an unlimited number of peripheral component cards with synchronized clock signals.

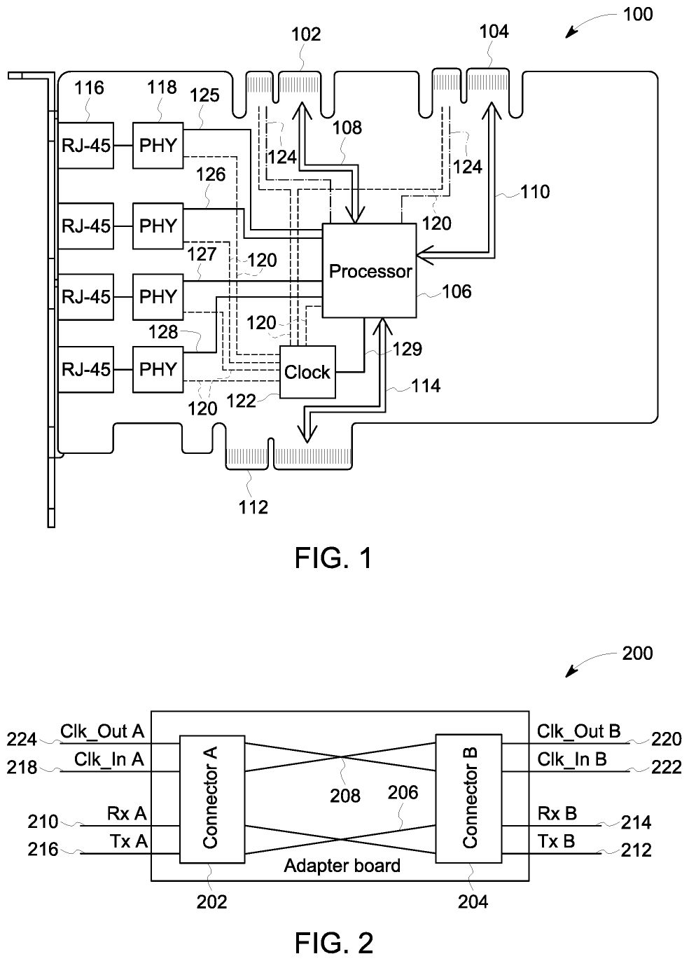

FIG. 1 is a block diagram of an example peripheral component card 100, in accordance with an illustrative embodiment. The example peripheral component card 100 includes a first communication extension port 102 and a second communication extension port 104. The first communication extension port 102 and second communication extension port 104 are communicatively coupled to a processor 106. In some embodiments, the processor 106 is a field programmable gate array (FPGA). In the exemplary embodiment, the first communication extension port 102 is coupled to the processor 106 via a first high-speed communication bus 108. The second communication extension port 104 is communicatively coupled to the processor 106 via a second high-speed communication bus 110. In some embodiments, high-speed communication busses 108 and 110 are dedicated to one of data transfer and clock signals. In other embodiments, high-speed communication busses 108 and 110 transmit both data and clock signals. In some embodiments, high-speed communication busses 108 and 110 are serial communication busses.

In the exemplary embodiment, the processor 106 is communicatively coupled to a motherboard interface 112 via a data bus 114. In the exemplary embodiment, the motherboard interface 112 is a peripheral component interface express (PCIe) connection. In some embodiments, the motherboard interface 112 is connected to a motherboard but does not communicate with the motherboard.

The peripheral component card 100 includes a plurality of peripheral component ports 116. In the exemplary embodiment, the peripheral component card 100 has four peripheral component ports 116. In the exemplary embodiment, the peripheral component ports 116 are RJ-45 ports configured for external communication. Each RJ-45 port 116 is coupled to a respective Ethernet physical layer transceiver (PHY) module 118. The processor 106 is in communication with peripheral component ports 116 via point-to-point direct connections 125, 126, 127, and 128. In some embodiments, the processor 106 may communicate with the PHY modules 118 via a single data bus. In the exemplary embodiment, the synchronous clock signal is generated by a clock generator 122 and is transmitted to the processor 106 and the PHY modules 118.

In some embodiments, the peripheral component ports 116 are communication ports for video and/or audio data transmissions (e.g., serial digital interface (SDI) transmissions), image processing, data filtration (e.g., digital signal processing applications), data acquisition, encryption and/or decryption preprocessing, etc., or some combination thereof.

The processor 106 is also communicatively coupled to a clock 122. In some embodiments, the clock 122 is an adjustable voltage-controlled crystal oscillator (VCXO) that generates a periodic signal. In other embodiments, clock 122 is an on-board oscillator configured to achieve the same results as described herein. The processor 106 transmits clock adjustment signals to clock 122, via the point-to-point direct connection 129, to alter the generated clock signal for applications that require clock synchronization. The PHY module 118 receives a clock signal from the clock 122 to synchronize the data stream. In the exemplary embodiment, the clock 122 transmits a clock signal via a clock channel 120 to the first communication extension port 102. In some embodiments, the clock signal may be transmitted via a clock bus and/or data bus. In other embodiments, the clock signal may be transmitted to another peripheral component card to synchronize other peripheral component cards to the clock frequencies of peripheral component card 100 via extension port 104.

In some embodiments, a clock signal may be received by the first communication extension port 102 for data synchronization. The synchronous clock signal is transmitted from clock 122 via the clock channel 120 to the processor 106, the PHY modules 118. Alternatively, the clock signal received from the communication extension port 102 is received by the processor to adjust the clock 122 and/or the PHY modules to align data synchronization with the incoming clock signal.

In some embodiments, a clock signal may be received by the second communication extension port 104. The clock signal is transmitted to the processor via clock channel 120. The processor transmits to the clock 122, PHY modules 118, and/or the first communication extension port 102 for data synchronization and/or transmitting to other peripheral component cards connected to the peripheral component card 100 via the first communication extension port 102. All busses described herein are bidirectional and may be configured to work in any variation to achieve the results described herein.

FIG. 2 is a block diagram of an example adapter board 200 for a multi-card system, in accordance with one embodiment of the disclosure. The adapter board 200 is used to bridge two peripheral component cards such as the peripheral component card 100 shown in FIG. 1. In the exemplary embodiment, the adapter board 200 is a rigid structure such as a printed circuit board (PCB). In other embodiments, cables, wires, or other means of communicatively coupling the peripheral component cards are used.

The adapter board 200 connects to the peripheral component cards 100 at the communication extension ports 102 and 104 shown in FIG. 1. Connector A 202 connects to the corresponding extension port 102 or 104 on a first peripheral component card 100 (not shown) and connector B 204 connects to an extension port 102 or 104 on a second peripheral component card 100.

The example adapter board 200 is a high speed data communication channel and uses crossover data channel 206. In the exemplary embodiment, the adapter board 200 also includes a crossover clock channel 208. For example, data received from the first peripheral component card 100 is received at a receiving channel Rx A 210. A connector A 202 transmits the data via the crossover data channel 206 to the connector B 204. The data is transmitted to the second peripheral component card 100 via a transmitting channel Tx B 212. Similarly, data received from the second peripheral component card 100 is received via a receiving channel Rx B 214. Connector B 204 transmits the data via the crossover channel 206 to connector A 202. The data is transmitted via the transmitting channel Tx A 216 to the first peripheral component card.

Alternative configurations of communication channels and/or pathways may be employed to work in any variation to achieve the results described herein. For example, a first adapter board 200 may be dedicated to clock synchronization while a second adapter board 200 may be dedicated to data transfer. In another embodiment, two adapter boards 200 may be dedicated to data transfer while data synchronization is achieved through other means described elsewhere herein.

Data synchronization is achieved between the peripheral component cards by a clock signal received from one of the peripheral component cards 100 and transmitted to the other peripheral component cards 100. A single peripheral component card 100 in the system may be designated a master, which transmits a clock signal to the other connected peripheral component cards 100 via the adapter boards 200. In the example adapter board 200, this is accomplished by receiving a clock signal via a clock input or Clk_In A channel 218. The clock signal is received by connector A 202 and transmitted to connector B 204. Connector B 204 transmits the clock signal to connected peripheral component cards 100 via Clk_Out B channel 220. The reverse application may similarly be achieved if a clock signal is received via a Clk_In B channel 222. The clock signal is received by connector B 204 and transmitted to connector A 202 via crossover clock channel 208. Connector A 202 transmits the clock signal via Clk_Out A channel 224. In the exemplary embodiment, the peripheral component card 100 that is designated as the master communicates with an attached motherboard via the motherboard interface 112. In some embodiments, a peripheral component card 100 designated the master might not communicate with the motherboard.

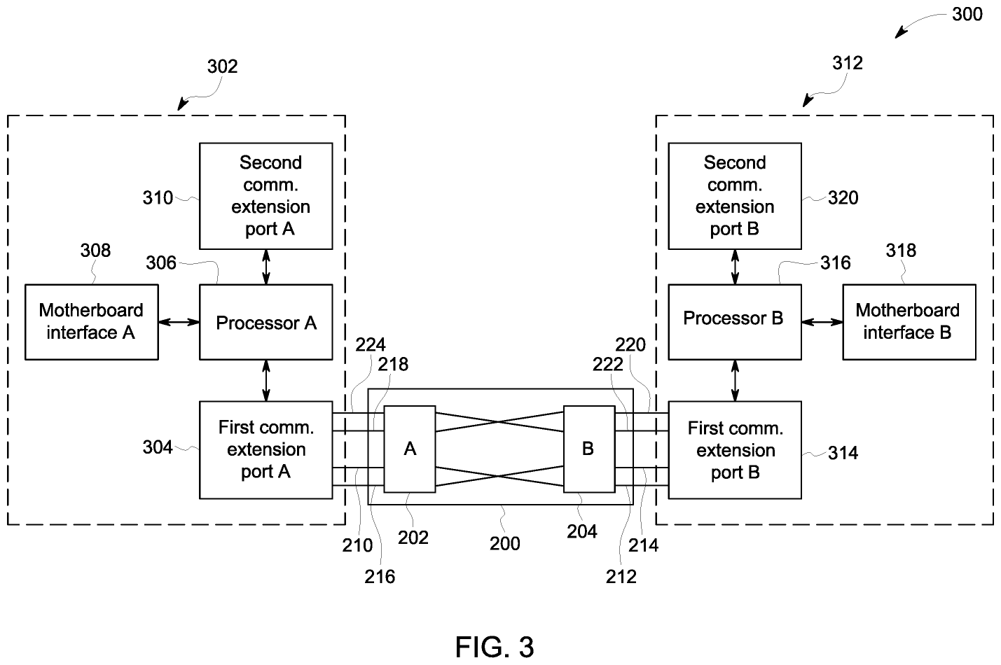

FIG. 3 is a flow diagram of the example peripheral component card 100 shown in FIG. 1 using the example adapter board 200 shown in FIG. 2 for a multi-card system 300, in accordance with one embodiment of the disclosure. The adapter board 200 is connected to peripheral component card A 302 via a first communication extension port A 304. Communication extension port A 302 is communicatively coupled to processor A 306. Processor A 306 communicates with the motherboard via motherboard interface A 308. Peripheral component card A 302 also includes an unconnected second communication extension port A 310. In some embodiments, another adapter board 200 is used to connect peripheral component card A 302 with peripheral component card B 312.

In the exemplary embodiment, peripheral component card A is connected to the adapter board 200 at connector A 202. The first communication port A 304 includes a data transmitter channel connected to connector A 202 at receiving channel Rx A 210. The first communication port A 304 receives data from the adapter board 200 via the transmitter channel Tx A 216. Additionally or alternatively, the first communication port A 304 includes a clock channel for transmitting a clock signal to the Clk_In A clock channel 218 of connector A 202. Connector A is also connected to the first communication port A 304 by a Clk_Out A clock channel 224 for transmitting a clock signal to the peripheral component card A 302.

The adapter board 200 is also connected to peripheral component card B 312 at connector B 204. Connector B 204 is connected to peripheral component card B 312 at the second communication extension port B 314. Connector B 204 includes a transmitter Tx B data channel 212 for transmitting data to the second communication extension port B 314. Connector B 204 also includes a receiving Rx B data channel 214 for receiving data from the first communication extension port B 314. Connector B 204 also includes a Clk_Out B clock channel 220 for transmitting a clock signal to the first communication extension port B 314. Connector B 204 also includes a Clk_In B clock channel 222 for receiving a clock signal from the first communication extension port B 314.

The first communication extension port B 314 is communicatively coupled to processor B 316. Processor B 316 is also in communicatively coupled to a motherboard interface B 318 that does not transmit or receive data from the motherboard. Processor B 316 is also communicatively coupled to a second communication extension port B 320 that is unconnected.

In the exemplary embodiment, data and clock signals are transmitted from peripheral component card A 302 to peripheral component card B 312 via the adapter board 200. In some embodiments, peripheral component card A 302 and peripheral component card B 312 includes peripheral component ports such as peripheral component ports 116 shown in FIG. 1. In some embodiments, motherboard interface A 308 and motherboard interface 318 are peripheral component interconnect express (PCIe) connections.

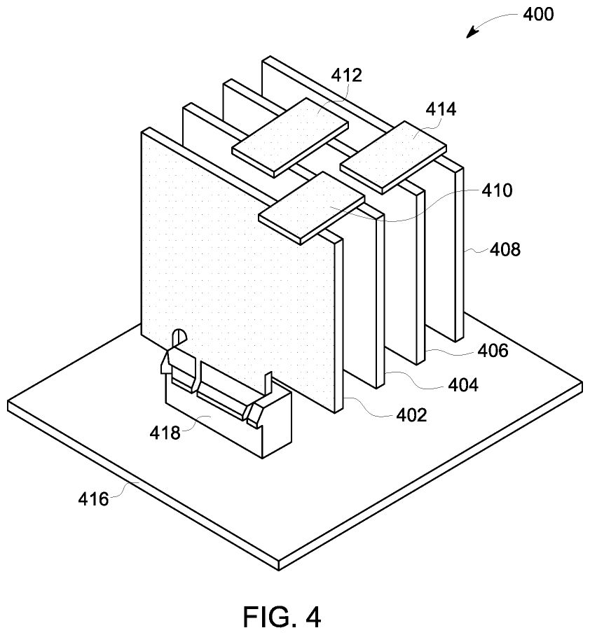

FIG. 4 illustrates an example four-card system 400 using peripheral component cards such as the peripheral component card 100 shown in FIG. 1 and adapter boards such as adapter board 200 shown in FIG. 2, in accordance with one embodiment of the disclosure. The example four-card system 400 includes four peripheral component cards 100 coupled to a motherboard 416 via connectors such as peripheral component interconnect (PCIe) slots 418. The peripheral component cards 402, 404, 406, and 408 are in communication via three adapter boards 410, 412, and 414. In the example four-card system, the peripheral component card 402 is connected to the peripheral component card 404 via the adapter board 410. The peripheral component card 404 is connected to the peripheral component card 406 via the adapter board 412. The peripheral component card 406 is connected to the peripheral component card 408 via the adapter board 414.

In the exemplary embodiment, the peripheral component card 402 is connected to the motherboard 416 via a motherboard interface 418. In some embodiments, the motherboard interface 418 is a PCIe slot. In the exemplary embodiment, the peripheral component cards 404, 406, and 408 do not communicate with the motherboard 416. In some embodiments, the peripheral component cards 404, 406, and 408 may each individually and/or in some combination communicate with the motherboard 416.

Data is transferred between the motherboard 416 and the peripheral component cards 404, 406, and 408 via the motherboard interface 418 connected to the peripheral component card 402 and via the adapter boards 410, 412, and 414. For example, data received by peripheral component card 402 from the motherboard 416 via the motherboard interface 418 is transmitted to the linked peripheral component card 404 via the adapter board 410. The peripheral component card 404 transmits the data to the linked peripheral component card 406 via the adapter board 412. The peripheral component card 406 transmits the data to the linked peripheral component card 408 via the adapter board 414. The data is transferred via the adapter boards 412, 414, and 410 via communication extension ports, such as the first communication extension port 304 and the first communication extension port B 314 shown in FIG. 3. The communication extension ports are coupled to adapter boards such as adapter board 200 as shown in FIG. 3.

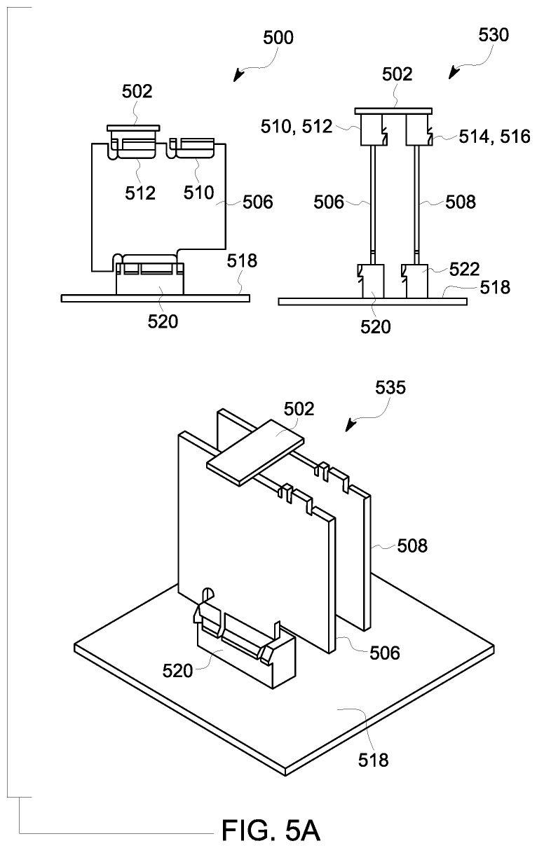

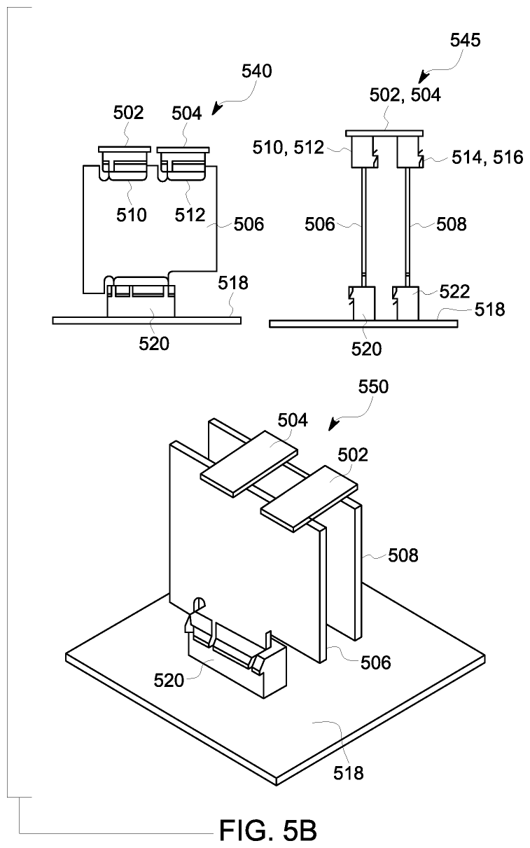

FIGS. 5A and 5B illustrate examples of two-card systems using the peripheral component card 100 shown in FIG. 1 and the adapter board shown in FIG. 2, in accordance with one embodiment of the disclosure.

FIG. 5A illustrates a plurality of views of an example two-card system using two peripheral component cards 100 shown in FIG. 1 and one adapter board 200 shown in FIG. 2, in accordance with one embodiment of the disclosure. View 500 presents a side view of the two-card system using a single adapter board 200. The two-card system includes one adapter board 502 coupled to two peripheral component cards 506 and 508. Peripheral component card 506 includes communication extension port 510 and 512. Peripheral component card 508 includes communication extension port 514 and 516.

The adapter board 502 is coupled to the peripheral component card 506 and 508 at communication extension ports 510 and 514 (shown in view 530). The adapter board 504 is coupled to the peripheral component cards 506 and 508 at communication extension ports 512 and 516 (shown in view 530). The peripheral component cards 506 and 508 are connected to the motherboard 518 via motherboard interfaces 520 and 522 (shown in view 530).

View 530 represents a perspective view of peripheral component cards 506 and 508 connected to adapter board 502 and motherboard 518 by motherboard interfaces 520 and 522. View 535 represents an angled view of the two-card system including peripheral component cards 506 and 508 connected to motherboard 518 at motherboard interface 520 and 522 and connected to adapter boards 502 and 504.

In the exemplary embodiment, adapter board 502 is configured for receiving and transmitting data between peripheral component cards 506 and 508, adapter board 502 a dedicated transmitting communication channel and dedicated receiving communication channel. In some embodiments, adapter board 502 is dedicated to unidirectional high-speed data transfer, such as from peripheral component card 506 to peripheral component card 508.

FIG. 5B illustrates a plurality of views of an example two-card system using two peripheral component cards 100 shown in FIG. 1 and two adapter boards 200 shown in FIG. 2, in accordance with one embodiment of the disclosure. View 540 in FIG. 5B presents a side view of the two-card system using two adapter boards which may be used to increase available bandwidth. The two-card system includes adapter boards 502 and 504 coupled to the peripheral component cards 506 and 508. Peripheral component card 506 includes communication extension port 510 and 512. Peripheral component card 508 includes communication extension port 514 and 516.

The adapter board 502 is coupled to the peripheral component card 506 and 508 at communication extension ports 510 and 514 (shown in view 545). The adapter board 504 is coupled to the peripheral component cards 506 and 508 at communication extension ports 512 and 516 (shown in view 545). The peripheral component cards 506 and 508 are connected to the motherboard 518 via motherboard interfaces 520 and 522 (shown in view 545).

View 545 represents a perspective view of peripheral component cards 506 and 508 connected to adapter boards 502 and 504 and motherboard 518 by motherboard interfaces 520 and 522. View 550 represents an angled view of the two-card system including peripheral component cards 506 and 508 connected to motherboard 518 at motherboard interface 520 and 522 and connected to adapter boards 502 and 504.

In the exemplary embodiment, adapter boards 502 and 504 are configured for receiving and transmitting data between peripheral component cards 506 and 508, each adapter board 502 and 504 having a dedicated transmitting and dedicated receiving communication channel. In some embodiments, adapter board 502 is dedicated to unidirectional high-speed data transfer from peripheral component card 506 to peripheral component card 508. In those embodiments, adapter board 504 is similarly dedicated to unidirectional high-speed data transfer from peripheral component card 508 to peripheral component card 506.

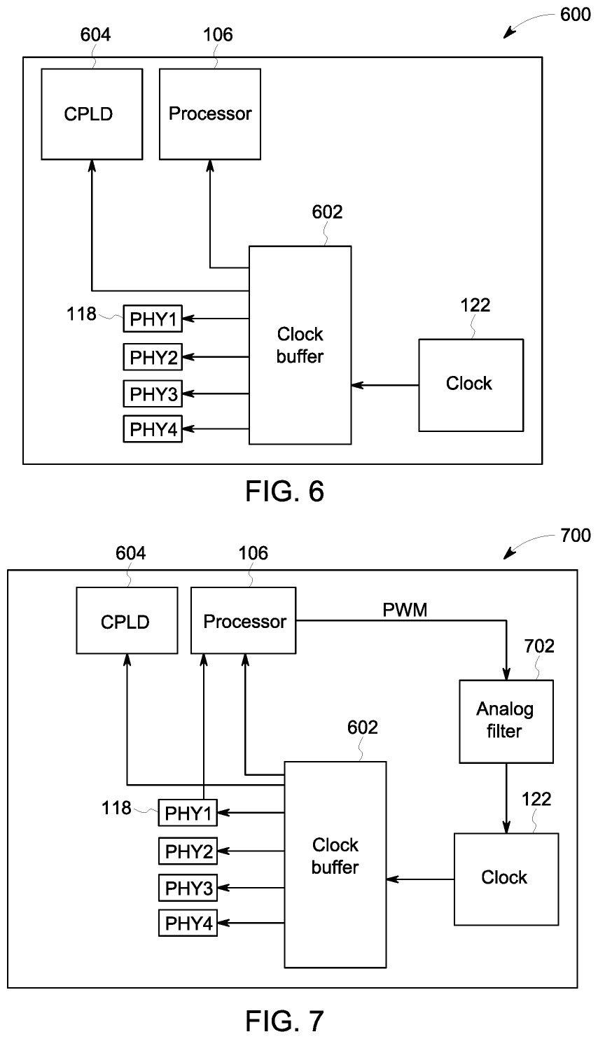

FIG. 6 is a flow diagram 600 of the clock signal distribution of the peripheral component card 100 shown in FIG. 1 with an example clock generator 122, in accordance with one embodiment of the disclosure. In some embodiments, the clock generator 122 is a voltage-controlled crystal oscillator (VCXO) generating a clock signal with a 25 MHz frequency. The clock generator 122 is communicatively coupled to a clock buffer 602. The clock buffer 602 is configured to distribute the clock signal to multiple components. In the exemplary embodiment, the clock buffer 602 is communicatively coupled to four PHY modules 118 for synchronizing data transmissions. The clock buffer 602 is also communicatively coupled to the processor 106. In some embodiments, the processor 106 uses the clock signal to synchronize the system. The clock buffer 602 is also communicatively coupled to other complex programmable logic devices (CPLD) 604. In the exemplary embodiment the clock generator 122 transmits a clock signal to the clock buffer 602. The clock buffer 602 redistributes the clock signal to the PHY modules 118, the processor 106, and the CPLD 604.

FIG. 7 is a flow diagram 700 of the clock signal distribution of the peripheral component card 100 shown in FIG. 1 with example external clock signal, in accordance with one embodiment of the disclosure. In the exemplary embodiment, the external clock signal is received by at least one of the PHY modules 118. The PHY modules 118 are communicatively coupled to the processor 106. The processor 106 is communicatively coupled to an analog filter 702. The processor 106 is configured to transmit a pulse width modulated (PWM) signal to an analog filter 702. The PWM signal is one method to adjust the clock although other methods may be used. The analog filter 702 is communicatively coupled a clock generator 122 and is configured to convert the received PWM signal to the clock generator 122 to adjust the clock generator 122. The clock generator 122 is communicatively coupled to a clock buffer 602 and is configured to transmit the adjusted clock signal to the clock buffer 602. The clock buffer 602 distributes the adjusted clock signal to the other components as described above.

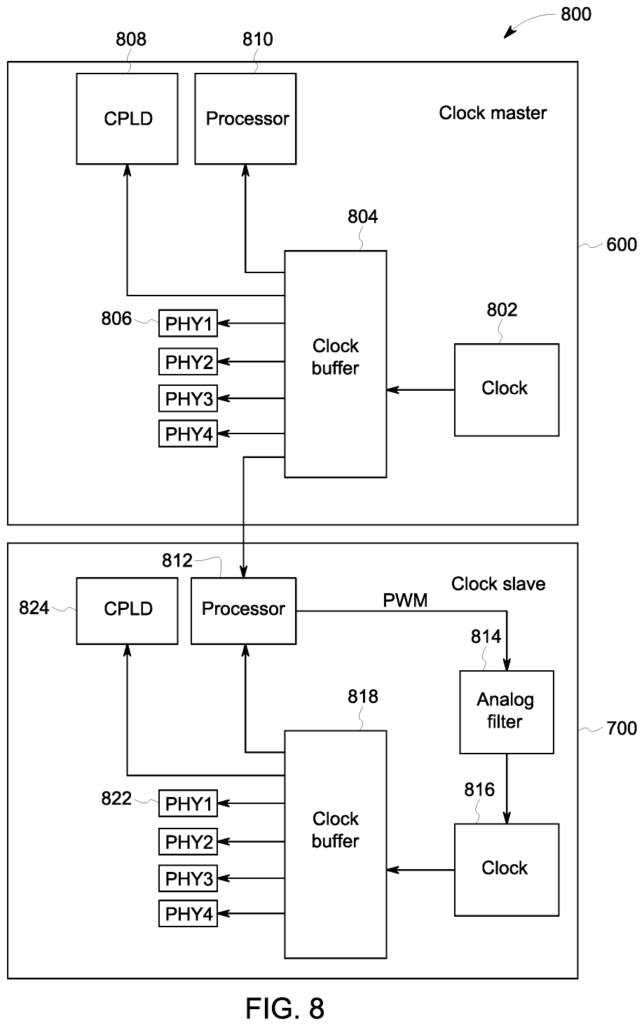

FIG. 8 is a flow diagram 800 of an example of clock synchronization with the peripheral component card 600 as shown in FIG. 6 and the peripheral component card shown in FIG. 7, in accordance with one embodiment of the disclosure. In the exemplary embodiment, the two-card system defines the peripheral component card 600 as the clock master and the peripheral component card 700 as the clock slave.

The peripheral component card includes a clock generator 802 to generate a clock signal. The clock signal is transmitted to a clock buffer 804 on the peripheral component card. The clock buffer 804 propagates the clock signal to the PHY modules 806, the CPLD 808, and the processor 810 on peripheral component card. The clock buffer 804 also transmits the clock signal to the peripheral component card via a communication extension port e.g. communication extension port 102 (not shown) coupled to an adapter board 200 (not shown). The adapter board transmits the clock signal to the processor 812 of peripheral component card via a communication extension port (not shown) on the peripheral component card.

The processor 812 of the peripheral component card transmits a PWM signal to an analog filter 814 of the peripheral component card to adjust the clock generator 816. The clock generator 816 transmits the adjusted clock signal to the clock buffer 818 on the peripheral component card. The clock buffer 818 distributes the updated clock signal, synchronized to the clock signal generated by the clock generator 802, to the PHY modules 822, CPLD 824, and processor 812 on the peripheral component card.

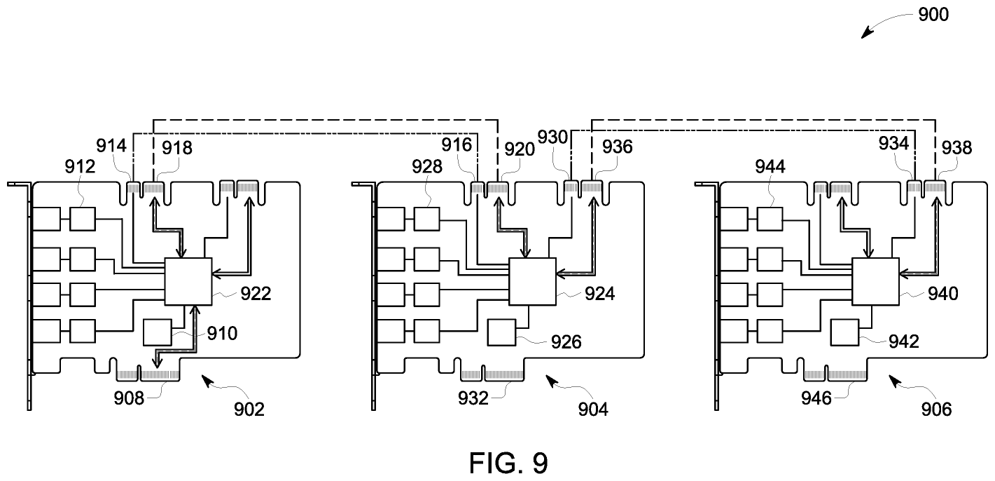

FIG. 9 is a flow diagram of an example three-card system 900 using the peripheral component card 100 shown in FIG. 1, and passive adapter boards 200 (not shown) in accordance with one embodiment of the disclosure. In the three-card system 900, a peripheral component card A 902 is designated the master while peripheral component cards B 904 and C 906 are configured for slave operation. Alternatively, or in some combination thereof, peripheral component cards B 904 or C 906 may be configured as the master with the other peripheral component cards configured for slave operation, respectively. The peripheral component card A 902 is communicatively coupled to a motherboard as shown in FIG. 4 via a motherboard interface A 908. The peripheral component card A 902 transmits and receives data via the motherboard interface A 908. The peripheral component card A 902 includes a clock generator A 910 which is communicatively coupled to PHY modules A 912 and communication extension port A-1 914.

The peripheral component card 902 A is connected to the peripheral component card B 904 via communication extension ports. The communication extension port A-1 914 is connected to a communication extension port B-1 916 on peripheral component card B 904 for transmitting and/or receiving clock signals. The extension communication port A-2 918 is connected to communication extension port B-2 920 for data transfer. A processor A 922 on the peripheral component card A 902 transmits or receives data to the motherboard via the motherboard interface A 908. The processor A 922 also transmits and receives data via the communication extension port A-2 918 to transfer data to peripheral component card B 904 at communication extension port B-1 916.

A processor B 924 receives the clock signal from communication extension port B-1 916. Processor B 924 transmits to the clock signal to clock B 926 on peripheral component card B 904. Clock B 926 propagates the clock signal to PHY modules B 928 and communication extension port B-3 930. Peripheral component card B 904 is coupled to the motherboard via motherboard interface B 932 but may not be configured to receive or transmit data via the motherboard interface B 932. In some embodiments, peripheral component card B 904 may transmit and receive data via the motherboard interface B 932.

Peripheral component card B 904 is connected to peripheral component card C 906 via extension ports. Communication extension port B-3 930 on peripheral component card B 904 is connected to communication extension port C-1 934 on peripheral component card C 906 for transmitting clock signals. Communication extension port B-4 936 on peripheral component card B 904 is connected to communication extension port C-2 938 on peripheral component card C 906. A processor C 940 receives the clock signal from communication extension port C-1 934 and transmits a signal to clock generator C 942. Clock generator C 942 propagates the clock signal to PHY modules C 944. The processor C 940 transmits and receives data to peripheral component card B 904 via communication extension port C-2 938. Peripheral component card C 906 is coupled to motherboard via the motherboard interface C 946 but may not be configured to transmit or receive data to via the motherboard interface C 946. In some embodiments, peripheral component card C 946 may transmit and receive data via the motherboard interface B 946.

In the exemplary embodiment, the clock generator A 910 generates a clock signal and transmits the clock signal via the communication extension port A-1 914 to the peripheral component card 904 at communication extension port B-2 920. The clock signal is received by the processor B 924 on the second peripheral component card 904. The processor B 924 updates the clock B 926 on the second peripheral component card 904. The clock signal is transmitted by the second peripheral component card 904 via communication extension port B-3 930. The third peripheral component card 906 receives the clock signal via communication extension port C-1 934. The processor C 940 on the third peripheral component card 906 receives the clock signal and updates the clock C 942 on the third peripheral component card 906 and propagates the clock signal to the other components on the card.

Data is transferred between the peripheral component cards A 902, B 904, and C 906 via the high-speed connections. The three-card configuration provides a single data-access point to the motherboard via the peripheral component card A 902. Peripheral component card B 904 and C 906 are coupled to the motherboard and may receive power but are not configured for data transfer. In some embodiments, data transfer can be optionally enabled via motherboard interface B 932 and 946 in this configuration.

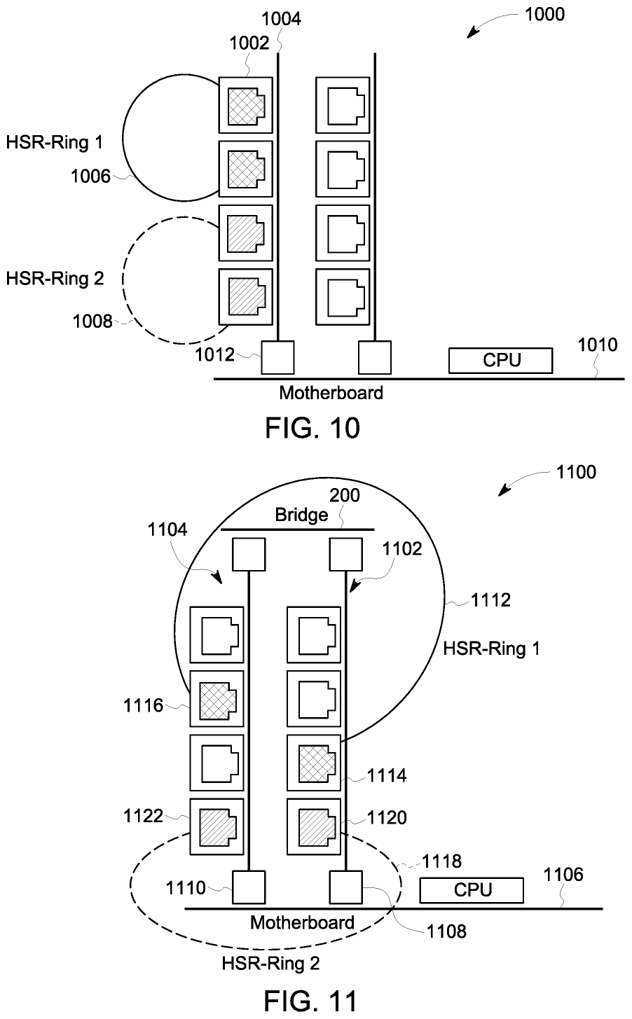

FIG. 10 illustrates an example redundancy network 1000 implemented by the single peripheral component card 100 shown in FIG. 1. High-availability seamless redundancy (HSR) ring networks may be created by two peripheral component ports 1002 on a single peripheral component card 1004. In some embodiments, multiple HSR ring networks may be joined by a system. In the exemplary embodiment, a single peripheral component card 1004 is used to join an HSR-Ring 1 1006 and an HSR-Ring 2 1008. The HSR-Ring 1 1006 network connection is achieved by using two peripheral component ports 1002 on the peripheral component card 1004. HSR-Ring 2 1008 network connection is achieved by using two peripheral component ports 1002 on the peripheral component card 1004. The peripheral component card 1004 is coupled to a motherboard 1010 via a motherboard interface 1012 for data transfer.

FIG. 11 illustrates an example redundancy network 1100 using a multi-card system, in accordance with one embodiment of the disclosure. The multi-card system may be implemented using the peripheral component card 100 shown in FIG. 1. In the exemplary embodiment, a peripheral component card A 1102 and a peripheral component card B 1004 are coupled to a motherboard 1106 by motherboard interface connections 1108 and 1110 respectively.

An HSR-Ring I 1112 is created and/or joined by connecting a first peripheral component port A 1114 on peripheral component card A 1102 to a first peripheral component port 1116 on peripheral component card B 1104. Similarly, an HSR-Ring II 1118 is created and/or joined by connecting a second peripheral component port 1120 on peripheral component card A 1102 to a second peripheral component port 1122 on peripheral component card B 1104.

In the exemplary embodiment, additional redundancy is provided in the event of failure of one of the peripheral component ports. Failure of peripheral component port 1116, network cables connected to peripheral component port 1116, and/or other component failures (e.g., the processor, clock generator, etc.) on peripheral component card 1104 may be supplemented by the corresponding component on peripheral component card 1102. For example, in the event the clock generator (not shown) on peripheral component port 1104 becomes unsynchronized, a synchronized clock signal may be transmitted from peripheral component card 1102 to peripheral component card 1104 via the adapter board 200. Use of additional peripheral component cards 100 further enhance reliability and reduce rates of failure by increasing the safe failure fraction and providing for the ability to achieve a higher safety integrity level (SIL). Other redundancy networks e.g. Parallel Redundancy Protocol (PRP) may be implemented using a multi-card system as described herein.

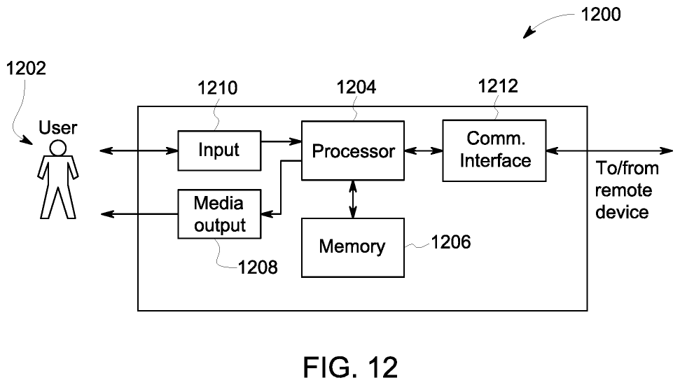

FIG. 12 illustrates an example configuration of a client system 1200 that may be used with a multi-card system using the peripheral component card 100 shown in FIG. 1. Client system 1200 is operated by a user 1202. Client system 1200 includes a processor 1204 for executing instructions. In some embodiments, executable instructions are stored in a memory area 1206. Processor 1204 includes one or more processing units (e.g., in a multi-core configuration). Memory area 1206 is any device allowing information such as executable instructions and/or transaction data to be stored and retrieved. Memory area 1206 may include one or more computer-readable media.

Client system 1200 also includes at least one media output component 1208 for presenting information to user 1202. Media output component 1208 is any component capable of conveying information to user 1202. In some embodiments, media output component 1208 includes an output adapter (not shown) such as a video adapter and/or an audio adapter. An output adapter is operatively coupled to processor 1204 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 1208 is configured to present a graphical user interface (e.g., a web browser and/or a client application) to user 1202. A graphical user interface includes, for example, an online store interface for viewing and/or purchasing items, and/or a wallet application for managing payment information. In some embodiments, client system 1200 includes an input device 1210 for receiving input from user 1202. User 1202 may use input device 1210 to, without limitation, select and/or enter one or more items to purchase and/or a purchase request, or to access credential information, and/or payment information. Input device 1210 includes, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen functions as both an output device of media output component 1208 and input device 1210.

Client system 1200 also includes a communication interface 1212, capable of communicating with, for example, the multi-card system implemented by a peripheral component card 100. Communication interface 1212 includes, for example, a wired or wireless network adapter and/or a wireless data transceiver for use with a mobile telecommunications network.

Stored in memory area 1206 are, for example, computer-readable instructions for providing a user interface to user 1202 via media output component 1208 and, optionally, receiving and processing input from input device 1210. The user interface includes, among other possibilities, a web browser and/or a client application capable of communicating with a peripheral component card 100. A client application allows user 1202 to interact with, for example, a peripheral component card 100. For example, instructions may be stored by a cloud service and the output of the execution of the instructions sent to the media output component 1208.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

Various embodiments of the disclosure may include one or more special purpose computers, systems, and/or particular machines that facilitate the receipt, processing, and/or output of analog and/or digital data. A special purpose computer or particular machine may include a wide variety of different software modules and/or computer-implemented or computer-executable instructions in various aspects. As explained in greater detail below, in certain aspects, these various software components may be utilized to facilitate the operation of an IO circuit and/or the processing of received analog or digital data.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), or any other circuit or processor capable of executing the functions described herein. The methods described herein may be encoded as executable instructions embodied in a computer readable medium, including, without limitation, a storage device or a memory device. Such instructions, when executed by a processor, cause the processor to perform at least a portion of the methods described herein. The above examples are exemplary only, and thus are not intended to limit in any way the definition or meaning of the term processor.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A multi-card system comprising:
a first peripheral component card comprising a first plurality of peripheral component ports configured for external communication, a first communication extension port, and a second communication extension port;
a second peripheral component card comprising a second plurality of peripheral component ports configured for external communication, a first communication extension port, and a second communication extension port; and
a first adapter board coupled to the first peripheral component card at the first communication extension port of the first peripheral component card and coupled to the second peripheral component card at the first communication extension port of the second peripheral component card,
wherein the first peripheral component card is coupled to a motherboard and is configured to transmit and receive data with the second peripheral component card via the first adapter board,
wherein the first peripheral component card is configured to transmit and receive data via the first plurality of peripheral component ports of the first peripheral component card and the second peripheral component card is configured to transmit and receive data via the second plurality of peripheral component ports of the second peripheral component card, and
wherein the first peripheral component card and the second peripheral component card are configured to route data between the first plurality of peripheral component ports, the plurality of peripheral component ports, and the motherboard.

2. The multi-card system of claim 1 wherein the first adapter board is configured to transmit a clock signal to at least one of the first communication extension port and the second communication extension port of the first peripheral component card.

3. The multi-card system of claim 1 further comprising:
a second adapter board coupled to the first peripheral component card at the second communication extension port on the first peripheral component card and coupled to the second peripheral component card at the second communication extension port on the second peripheral component card.

4. The multi-card system of claim 1, further comprising a second adapter board coupled to the second communication extension port of the second peripheral component card and coupled to a second communication extension port of a third peripheral component card.

5. The multi-card system of claim 4, further comprising:
a processor on the first peripheral component card configured to:
transmit and receive data with the motherboard; and
transmit and receive data with the second peripheral component card;
a processor on the second peripheral component card configured to transmit and receive data with the third peripheral component card; and
a processor on the third peripheral component card configured to transmit and receive data with the second peripheral component card.

6. The multi-card system of claim 4, further comprising a third adapter board coupled to the third peripheral component card at a first communication extension port on the third peripheral component card and coupled to a fourth peripheral component card at a first communication extension port on the fourth peripheral component card.

7. The multi-card system of claim 1, further comprising a plurality of Ethernet ports on each peripheral component card.

8. The multi-card system of claim 7, further comprising a processor on the first peripheral component card programmed to transmit a clock signal to the plurality of Ethernet ports on each peripheral component card such that data transmitted to and received from the plurality of Ethernet ports is synchronized to said clock signal.

9. The multi-card system of claim 8, wherein a clock signal is received from a first Ethernet port of the plurality of Ethernet ports to be used by the processor to synchronize the data.

10. The multi-card system of claim 1, wherein the first adapter board is attached perpendicularly to the first and second peripheral component cards.

11. A peripheral component card comprising:
a first communication extension port for transmitting and receiving a clock signal and for transmitting and receiving data;
a second communication extension port for transmitting and receiving a clock signal and for transmitting and receiving data;
an on-board clock generator;
a plurality of peripheral component ports; and
a processor communicatively coupled to the first communication extension port, the second communication extension port, and the plurality of peripheral component ports, the processor programmed to:
receive a clock signal;
synchronize the on-board clock generator to the received clock signal;
transmit and receive data synchronized to the clock signal with one of the first communication extension port and second communication extension port; and
transmit and receive data synchronized to the clock signal with at least one of the plurality of peripheral component ports.

12. The peripheral component card of claim 11 further comprising a motherboard interface, wherein the processor receives a clock signal via the motherboard interface.

13. The peripheral component card of claim 11, wherein the processor receives a clock signal from one of the plurality of peripheral component ports.

14. The peripheral component card of claim 11, wherein the processor receives a clock signal from one of the first communication extension port and the second communication extension port.

15. The peripheral component card of claim 11, wherein the peripheral component card is designated a master and transmits a clock signal to the first communication extension port.

16. The peripheral component card of claim 11, wherein the peripheral component card is designated a slave and the processor receives a clock signal from the second communication extension port.

17. The peripheral component card of claim 11, wherein the on-board clock generator is configured to:
generate an on-board clock signal;
receive a clock adjustment signal from the processor;
adjust the on-board clock generated based on the received clock adjustment signal;
transmit the on-board clock signal to the first communication extension port;
transmit the on-board clock signal to the second communication extension port; and
transmit the on-board clock signal to the plurality of peripheral component ports.

18. The peripheral component card of claim 17 further comprising a clock buffer and an analog filter, wherein the processor is programmed to transmit a pulse width modulated signal to the analog filter, wherein the analog filter is configured to transmit an on-board clock adjustment signal to the on-board clock generator, and wherein the on-board clock generator is configured to transmit the on-board clock signal to the clock buffer.

19. The peripheral component card of claim 11, wherein the first communication extension port comprises a first connection and a second connection, the first connection dedicated to clock signals and the second connection dedicated to high-speed data.

20. The peripheral component card of claim 11, wherein the second communication extension port comprises a first connection and a second connection, the first connection dedicated to clock signals and the second connection dedicated to high-speed data.

21. A computer system comprising:
a motherboard;
a first peripheral component card including a first plurality of peripheral component ports configured for external communication, the first peripheral component card coupled to the motherboard;
a second peripheral component card including a second plurality of peripheral component ports configured for external communication, the second peripheral component card coupled to the motherboard;
a first adapter board coupled to the first peripheral component card at a first extension port of the first peripheral component card and the second peripheral component card at a first extension port of the second peripheral component card; and
a processor coupled to the motherboard and in communication with the first peripheral component card, the second peripheral component card, the processor programmed to:
receive, via the first plurality of peripheral component ports of the first peripheral component card, data from a network;
route the data between the first plurality of peripheral component ports, the second plurality of peripheral component ports, and the motherboard.

22. The computer system of claim 21, wherein the processor is further programmed to receive, via a second network connection with the second peripheral component card, data from the network.

23. The computer system of claim 21, wherein the processor is further programmed to transmit data to the network using at least one of the first peripheral component card and the second peripheral component card.

24. The computer system of claim 21, wherein the processor is further programmed to receive data from the network via the first peripheral component card, and transmit data to the network via the second peripheral component card.

25. The computer system of claim 21, further comprising a clock communicatively coupled to the processor, wherein the clock is configured to generate a clock signal and the processor is programmed to transmit the clock signal to the first peripheral component card.

26. The computer system of claim 21, wherein the processor receives a clock signal from the first peripheral component card.
